(19) United States
(12) Patent Application Publication
(10) Pub. No.: US 2022/0084371 A1
(43) Pub. Date: Mar. 17, 2022

(54) SYSTEMS AND METHODS FOR UNSUPERVISED DETECTION OF ANOMALOUS CUSTOMER INTERACTIONS TO SECURE AND AUTHENTICATE A CUSTOMER SESSION

(71) Applicant: Capital One Services, LLC, McLean, VA (US)

(72) Inventors: Sergey E. Semichev, Sterling, VA (US); Alexander Ignatov, Ashburn, VA (US)

(21) Appl. No.: 17/018,527

(22) Filed: Sep. 11, 2020

(51) Int. Cl. G07F 19/00; G06N 3/04; H04L 29/06

(52) U.S. Cl. CPC G07F 19/207; G06N 3/049; H04L 2463/082; H04L 63/1425; H04L 63/0892

(57) ABSTRACT

A system includes memory devices storing instructions, and one or more processors configured to execute instructions performing method steps. The method may include self-supervised training of a bidirectional recurrent neural network (RNN) model to enable reconstruction of an input vector from a global latent vector. The training may optimize parameters for real-time anomaly detection of customer interactions. The global latent vectors may comprise encrypted representations of customer behavior. After training, the system may produce optimized vector embeddings to represent customer behavior using a trained encoder of the model. The encoder may encrypt vectors in real-time for each customer session and determine a security measurement between vectors associated with previous customer sessions and a current session. Based on the security measurement, the system may require an additional security action from a customer to authenticate a customer session. The system may retrain and optimize the model in a self-supervised manner.

The present disclosure relates generally to a system implementing a computer model in which learning, such as through unsupervised training, continuous and/or iterative retraining of the model, can be utilized to determine potentially anomalous customer interactions for a respective customer and/or across a customer population in substantially real-time.

### BACKGROUND

Various applications utilize machine learning to enable a computer system to progressively improve performance on a task. Machine learning processes are commonly divided into two separate phases. The first phase involves the training of a model. Once the model is adequately, trained, the model is applied to some application or task, with the aim that the model will adequately improve in performance over time. However, machine learning models often require extensive efforts to label the data (supervised training) in order to handle a specific application. Additionally, machine learning models for detecting anomalous financial behavior may be difficult to implement in substantially real time environment to provide an automated anti-fraud analysis for ATM customer interactions because of the complexity of training the model and having the model perform analysis quickly enough to resolve a respective potentially fraudulent transaction before the ATM session ends.

Accordingly, there is a need for improved devices, systems, and methods for self-supervised and/or unsupervised training methods and implementation of a model for detecting anomalous ATM customer interactions for a respective ATM customer in real-time and for detecting anomalous behavior across a population, for example associated with a temporal and/or geographic anomaly.

### SUMMARY

Disclosed embodiments provide systems and methods for providing a self-supervised machine learning model configured to optimize according to an objective function associated with encrypting a global latent vector based on customer interaction data aggregated from a plurality of customer interactions with a secure device. In some embodiments, the secure device may be an automated teller machine (ATM) and the plurality may be a plurality of ATM customer interactions. More specifically, the system may be configured to receive ATM customer interaction data, tokenize the ATM customer interaction data by transforming the data array into a plurality of tensors and encrypting a first global latent vector based in part on the plurality of tensors. The global latent vector may be a compressed representation of the data contained in the plurality of input tensors. The model may then decrypt the first global latent vector to form an output plurality of tensors, and iteratively calculate a security (error) measurement between the input plurality of tensors and the output plurality of tensors. The model may reduce a difference between the first plurality of tensors and the second plurality of tensors according to an objective function. Accordingly, the model may undergo self-supervised training procedure to learn how to represent complicated customer ATM interaction data in a tokenized format of a plurality of tensors. The model may employ a bidirectional recurrent neural network (RNN) in order to enable the detection of anomalous ATM customer interactions to secure and authenticate a customer session. Once the model has completed the unsupervised learning process of latent vectors (e.g., latent vector embeddings), the system may additionally receive a second data array that includes customer interaction data, encrypt the second data array into a customer session vector using the trained model, and calculate a security measurement between the customer session vector and a portion of the first global latent vector from the training portion of the model. When the security measurement does not exceed a predetermined threshold, the system may transmit instructions to an ATM indicative of an anomalous session and requiring an additional security action from the customer before the customer session may be authenticated. When the security measurement exceeds the predetermined threshold, the system may transmit instructions for authentication of the first customer session by the ATM.

Consistent with the disclosed embodiments, the disclosed technology may include an anomaly detection device in communication with one or more financial service provider system(s). Each financial service provider system may include a plurality of ATMs with which customers may interact and a distributed memory grid for storing ATM customer vectors based on ATM customer interaction data. In some embodiments, an exemplary method may include receiving ATM customer interaction data in a first data array. The system may tokenize the ATM customer interaction data by transforming the first data array into a first plurality of tensors. The tensors may represent aggregate but uncompressed customer interaction data. The system may, using a bidirectional recurrent neural network (RNN), encrypt an input global latent vector based on the first plurality of tensors. The first global latent vector may be a compressed representation of the customer interaction data in the first plurality of tensors. In the training sequence, the system may decrypt the first global latent vector to form the second plurality of tensors. The system may reduce a difference (e.g., minimize an error) between the first plurality of tensors and the second plurality of tensors according to an objective function of the bidirectional RNN model. In some embodiments, reducing a difference may include maximizing the similarity between the second plurality of tensors and the first plurality of tensors by iteratively recalculating the first global latent vector while adjusting respective weights of each layer of the bidirectional RNN model.

In some embodiments, once the model has undergone sufficient unsupervised training (e.g., when the error measurement between the input plurality of tensors and the output plurality of tensors has been minimized), the system may receive a second data array including a first customer session with a first ATM, transform the second data array into a first customer session vector, and calculate a security measurement between a first portion of the first global latent vector that is indicative of one or more previous first customer sessions, and the first customer session vector. When the security measurement does not exceed a predetermined threshold, the system may transmit instructions indicative of an anomalous session and requiring an additional security action from the customer before the customer session may be authenticated. When the security measurement exceeds the predetermined threshold, the system may transmit instructions for authentication of the first customer session by the ATM.

In some embodiments, once the model has undergone sufficient unsupervised training, the system may identify a first portion of the first global latent vector and a third portion of the first global latent vector, and calculate the security measurement between the first portion and the third portion of the first global latent vector. The first portion may be indicative of a first subgroup of ATM customer interactions for a first subgroup of customers and associated with a respective time period or geographic location and the third portion may be indicative of second subgroup of ATM customer interactions for the first subgroup of customers but not associated with the respective time period or geographic location. The system may calculate the security measurement between the first portion and the third portion of the first global latent vector. When the similarity measurement does not exceed a predetermined threshold, the system may determine one or more geographic or temporal anomalies with the first subgroup of customers.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1A is a representation of an existing model methodology for tokenizing ATM customer session data into a plurality of tensors;

FIG. 1B is a representation of an example model methodology for self-supervised training method of the model;

FIG. 2 is a representation of an example model methodology for detecting anomalous customer activity during a customer session, in accordance with some embodiments;

FIG. 3 is a flowchart of an exemplary method of unsupervised detection of anomalous customer interactions during a customer session, in accordance with some embodiments;

FIG. 4 is a flowchart of an exemplary method of identifying one or more geographic or temporal anomalies associated with a first subgroup of customers, in accordance with some embodiments;

FIG. 5 is a flowchart of another exemplary method of unsupervised detection of anomalous customer interactions during a customer session, in accordance with some embodiments;

FIG. 6 is a diagram of an exemplary system that may be used for unsupervised detection of anomalous customer interactions during a customer session and/or identifying one or more geographic or temporal anomalies associated with a first subgroup of customers, in accordance with some embodiments; and

FIG. 7 is a component diagram of an exemplary system for unsupervised detection of anomalous customer activity, according to some embodiments.

### DETAILED DESCRIPTION

Throughout this disclosure, certain example embodiments are described in relation to systems and methods for providing a trainable controller configured to learn from an indexed memory. But embodiments of the disclosed technology are not so limited. In some embodiments, the disclosed technology may be effective in decoupling an unsupervised training module or function of the system from a security management module or function of the system. In some embodiments, the disclosed technology may be effective in optimizing a global latent vector based on an objective function. Those having skill in the art will recognize that the disclosed technology can be applicable to multiple scenarios and applications.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The disclosed embodiments are directed to systems and methods for unsupervised detection of anomalous automated teller machine (ATM) customer interactions during a customer session. In some embodiments, the trainable controller may be configured to incrementally improve the similarity between a first plurality of tensors (e.g., corresponding to uncompressed customer ATM interactions) and a second plurality of tensors re-encrypted from a first global latent vector (e.g., a compressed data structure corresponding to the customer ATM interactions) without a need to supervise the training of the model. Thus, according to some embodiments, the disclosed technology may provide a system configured to continually improve its ability to autonomously detect anomalous ATM customer activity, which has been challenging for existing system and methods.

Although various embodiments may be described with respect to a system, a non-transitory computer-readable medium, and a method, it is contemplated that embodiments with identical or substantially similar features may alternatively be implemented as methods, systems, and/or non-transitory computer-readable media.

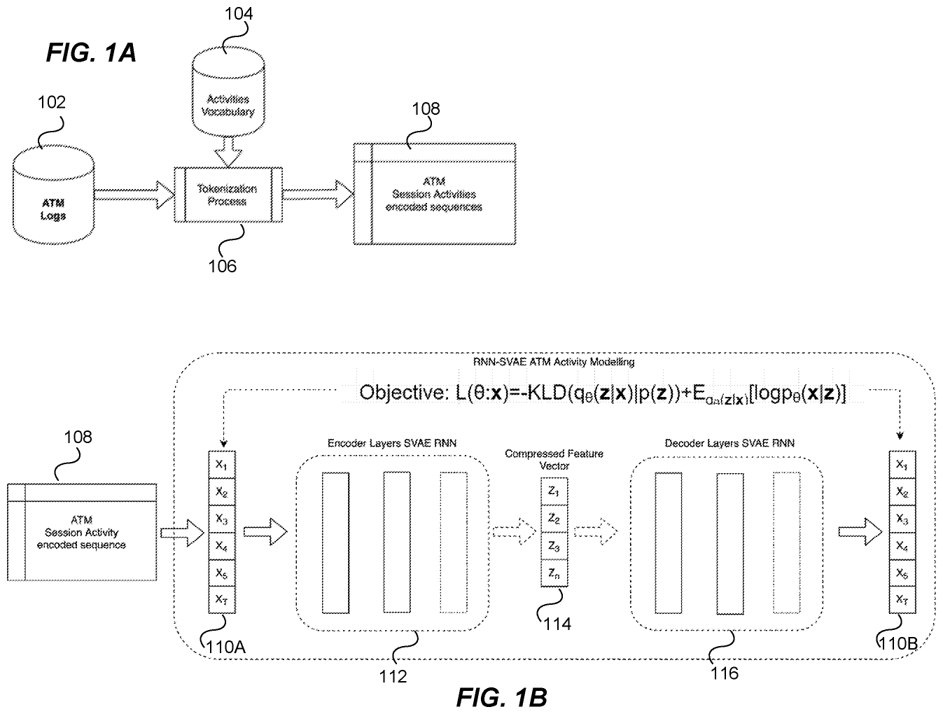

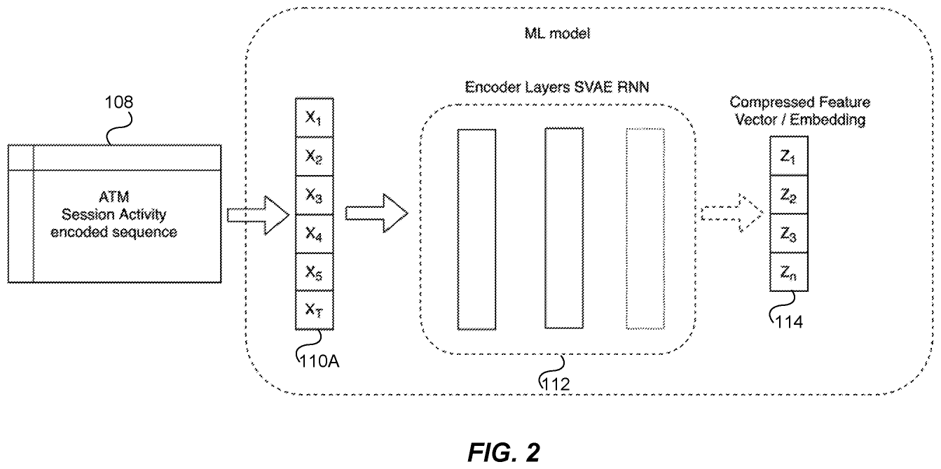

In some embodiments, the system may implement a bidirectional implementation of a recurrent neural network in order to encrypt the ATM customer activity into a compressed data structure (e.g., a global latent vector, as describe in more detail with respect to FIGS. 1A-1B and FIG. 2), and decrypt the compressed data structure and attempt to reconstruct the full corpus of ATM customer activity from the compressed data structure. The model may attempt to autonomously adjust and recalculate the compressed data structure in order to improve the accuracy with which the full corpus of ATM customer activity may be reconstructed from the compressed data structure. The bidirectional recurrent neural network may include a plurality of neural network layers, which act to emulate a human neural network in order to learn a specific task or tasks. A bidirectional recurrent neural network may connect two hidden layers of opposite directions to the same output. This allows a bidirectional neural network model to receive context information from past states and future states simultaneously during training, improving quality of latent vectors. In some embodiments the bidirectional RNN model may be combined with a mechanism to improve the ability of the model to create contextual connection between session activities that are distant in the input sequence. For example, the mechanism may comprise an attention mechanism that is combined with an input to the RNN allowing the RNN to focus on certain parts of the input sequence when predicting other parts of the output sequence, which may enable superior self-supervised learning of the model. In other embodiments, the mechanism may comprise one of a long short-term memory mechanism (LSTM) and/or a gated recurrent unit (GRU). In some embodiments, a GRU may be implemented in tandem with an attention mechanism to improve to bidirectional RNN model, while in other embodiments, a LSTM may be implemented in tandem with an attention mechanism to improve the bidirectional RNN model. In a preferred embodiment, the mechanism is preferably an attention mechanism.

Reference will now be made in detail to example embodiments of the disclosed technology, examples of which are illustrated in the accompanying drawings and disclosed herein. Wherever convenient, the same references numbers will be used throughout the drawings to refer to the same or like parts.

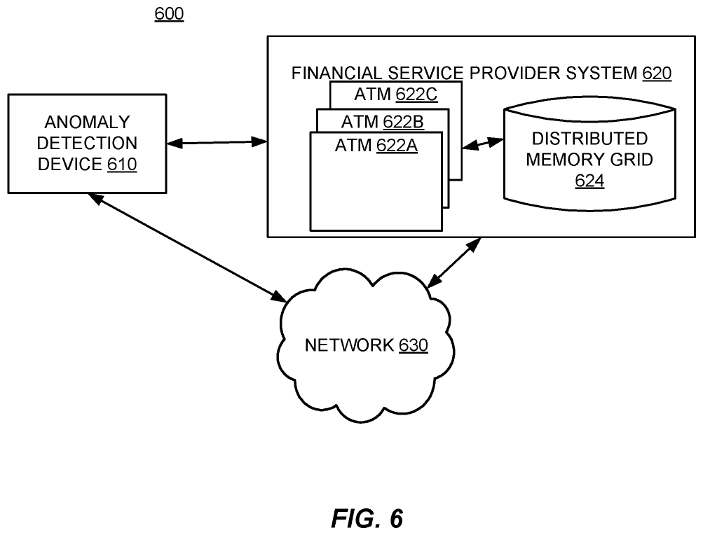

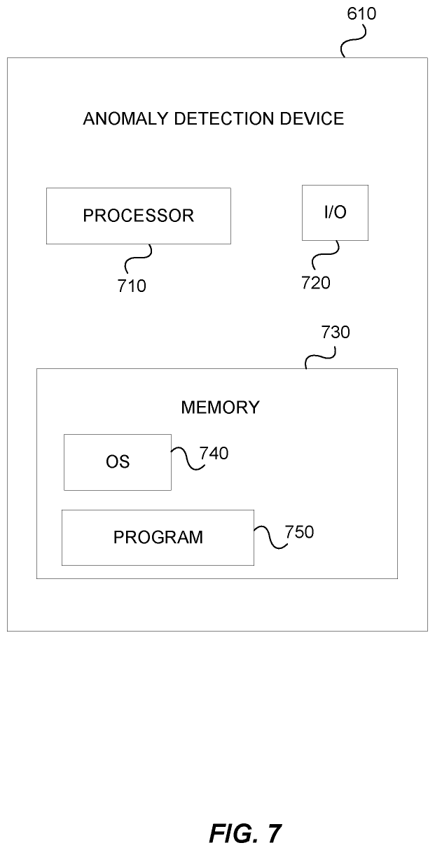

Referring to FIG. 1A, the system (e.g., anomaly detection system 600, as described in more detail with respect to FIGS. 6-7) may receive ATM logs 102 comprising ATM customer data for a plurality of customers. ATM logs 102 may include data associated with a customer ATM session, including data indicative of every action taken by the customer during the interaction. For example, ATM logs 102 may include data indicating that the ATM customer entered his or her PIN incorrectly on the first attempt or customer does not check balance before attempting to withdraw unusual for a given customer amounts of cash, and may include customer mouse movement (scrolling, clicking, page navigation), as well as another other interactions the customer may have with any respective hardware component of an ATM. ATM log 102 may also include geographic location data associated with the customer session, and a time stamp indicative of a time period during which the interaction occurred. The ATM log data 102 may be received in a data array format, wherein entries in the data array indicate every action and recorded detail of the ATM customer interaction. When a customer interacts with a respective hardware component of an ATM, the respective ATM hardware component generates a log that is included in ATM log 102. The system may monitor for and process each customer session of ATM log data. Each customer session may be identified by a customer identifier key value, with each action of an ATM log 102 including a respective customer identifier key value which identifies a respective customer. Accordingly, the system may be able to identify which portions of ATM log data 102 correspond to a respective customer.

First, the system (e.g. anomaly detection system 600) may employ a tokenization process 106 in which an activities vocabulary 104 is derived from the ATM logs 102 during the tokenization process. Tokenization process is referred as methods to split and encode raw sequences of ATM logs (text or binary) to a machine-readable form consumable by a machine learning model. It may consist of process of normalizing data as well as converting it through an established vocabulary (e.g., data dictionary) of possible ATM session activities to be encoded as sequence of numbers. The vocabulary (e.g., data dictionary) may be built by the process of assigning each unique token seen in the ATM logs a consecutive or random, but unique number. The initial vocabulary creation might be performed on all ATM transaction logs ever recorded and/or presently available to the system. Such an association allows the system to calculate the plurality of numerical tensors and perform computations regardless of the format of the original ATM logs. Because the plurality of possible ATM activities are limited by its nature and deterministic—it is possible to build a finite vocabulary (e.g., data dictionary) on potentially infinite amount of ATM logs which enables the system to lookup a distinct numerical representation for each token (e.g., word) that might be seen in the ATM logs. Highly unique values which may appear in the ATM logs (such as transaction IDs) may be automatically detected and assigned a common number. This procedure may be embedded in the tokenization module such that irrelevant and high cardinality values may be automatically assigned the same common number (e.g., numerical representation), to prevent unwanted inflation of the data dictionary. In some embodiments, the data dictionary (e.g., vocabulary) may be built before the initial model training begins. Consecutive model retraining may use the same data dictionary (e.g., vocabulary) and may include adding new (e.g., previously unseen) tokens and corresponding numbers to the existing data dictionary. In some embodiments, the tokenization process comprises transforming a plain text corpus of the ATM logs 102 into ATM session activities encoded sequences 108. In some embodiments, the ATM session activities encoded sequences 108 may be represented by a plurality of tensors. The model employed by the anomaly detection system 600 may pre-process ATM logs 102 and tokenize the ATM logs 102 to be represented by the plurality of tensors generated in 108. Accordingly, anomaly detection system 600 may be configured to receive data arrays comprising a plain text corpus of ATM logs 102, and transform the ATM customer activity data of ATM logs 102 into encoded sequences 108 comprising a plurality of tensors. The tensors may include numerical data entries that are representative of the ATM session activities 102, and may be interpretable by the system using the token vocabulary 104. Once the ATM logs 102 have been transformed into a plurality of tensors in the pre-processing workflow, the system may undergo self-supervised training, as discussed in more detail with respect to FIG. 1B.

As shown in FIG. 1B, the anomaly detection system 600 may employ a model to transform the ATM encoded sequence (e.g., a first plurality of tensors based on ATM log 102) into an input paragraph vector 110A. For example, the ATM encoded sequences 108 (e.g. customer session activities) may be preprocessed into an input vector (e.g., paragraph vector 110A). The bidirectional RNN model may employ an encoding layer 112 to encrypt the input vector into a global latent vector 114. The global latent vector 114 may be calculated for each respective customer session based on ATM logs 102 that may be received in substantially real time from ATMs, and these global latent vectors may be stored in a distributed data grid to be used during an authentication process in which the system may detect an anomalous session and transmit instructions requiring an additional security action from an ATM before authenticating a customer session. During training of the bidirectional RNN, once a global latent vector 114 is calculated, a decoding layer 116 of the bidirectional RNN model may decrypt the global latent vector into an output vector (e.g. output paragraph vector 110B). The model may reduce the difference (e.g., optimize) the model according to an objective function in order to minimize the error or discrepancy between the input vector and the output vector (e.g., the difference between input paragraph vector 110A and output paragraph vector 110B). Paragraph vectors may be based on concatenating the plurality of tensors (e.g., ATM encoded sequences 108) into the input paragraph vector 110A. The input paragraph vector 110A may be the input of the self-supervised learning method. Based on the input paragraph vector 110A, the system may encrypt a first global latent vector 114 using an encoder of a bidirectional recurrent neural network (RNN). The first global latent vector 114 may be a compressed data structure that includes the information contained by the input paragraph vector 110A. The first global latent vector 114 may be decrypted by a decoder of the bidirectional recurrent neural network 116 to form an output paragraph vector 110B. In order to undergo self-supervised training, anomaly detection 600 may reduce a difference (e.g., an error) according to an objective function. Accordingly, the system may iteratively recalculate the global latent vector 114 and adjust weights associated with each connected layer of the bidirectional RNN 112. Thus, the system may discover the most appropriate weights to maximize the similarity between the input paragraph vector 110A and the output paragraph vector 110B when those paragraphs are semantically similar. In the context of ATM activity, anomaly detection that may be understood as determining semantically similar activities between different ATM sessions. In some embodiments, the objective function may be expressed as the following:

L(θ:x)=−KLD(q_{θ}(z|x)|p(z))±E_{qθ(z|x)}[log p_{θ}(x|z)] (1)

Where x refers to the input (or output, as the system iteratively approaches an ideal 1:1 match between the input and output paragraph vectors) paragraph vector 110A and/or output paragraph vector 110B, z refers to the global latent vector encrypted using the encoding layer of the bidirectional RNN. The term: KLD (q_{θ}(z|x)|p(z)) of Equation (1) may correspond to amount of extra information needed in addition to the global latent vector in order to create samples representing input vectors. In other words, this term may represent the computed error associated with the transformation of the input vector 110A into the global latent vector 114. KLD may be understood as the Kullback-Leibler divergence (e.g., a measure of how one probability distribution differs from another). The term (q_{θ}(z|x)|p(z)) may be understood as the posterior distribution of the latent vector based on input vector x given a prior distribution for the global latent vector p(z). The term E_{qθ(Z|X)}[log p_{θ}(x|z)] may correspond to likelihood of constructing correct output (which aimed to be similar to input) from latent vector. In other words, this term may represent the computed error associated with the transformation of the global latent vector 114 into the output vector 110B by the decoding layer 116 of the bidirectional RNN. The term E_{qθ(z|x)}[log p_{θ}(x|z)] represents the log likelihood that from a given global latent vector 114 the model will output the output vector 110B that is most similar to the input vector 110A. These two terms of the objective function allow the model to simultaneously minimize the error associated with the encoding layer 112 encrypting input vector 110A into global latent vector 114 and minimize the error associated with the decoding layer 116 transforming global latent vector 114 into output 110B that attempts to reconstruct input vector 110A during the self-supervised learning process. θ may be understood as the model parameters (e.g., weights) that may be iteratively adjusted during the training of a model. In some embodiments, the encoding layer of bidirectional RNN may further include one or more algorithms which improves capturing complex contextual relations between different items in a sequence. These terms represent objective for the encoder part of the model during training phase as well as decoder part of the model. Anomaly detection system 600 may utilize additionally attention layers techniques, a long short-term memory (LSTM) or a gated recurrent unit (GRU), to improve the model performance by better capturing temporal and contextual interdependencies between parts of ATM logs sequences. After the model has been trained, the system may simply utilize the trained encoder layer to encrypt the vector embeddings (e.g. global latent vector(s) 114) without implementing the decoder layer of the model, because the decoder layers are utilized to guide the self-supervised learning process of representing input vectors (e.g. paragraph/input vectors 110A) as a compressed data structure of an embedding vector (e.g., global latent vector 114).

Referring to FIG. 2, once the anomaly detection system 600 has undergone unsupervised training and reduced the difference between the input and outputs according to the objective function (1) and determined optimal weights for the encoder layers of the bidirectional RNN 112, the system may be used to determine anomalous ATM activity for a particular user and secure a customer session. During training, the system may iteratively calculate global latent vectors 114 for all the available ATM logs 102. The ATM log 102 may be associated with a respective customer session that may be identified by a customer session identifier. For each customer session identifier, a global latent vector 114 (e.g. a vector embedding) may be stored in a distributed memory grid (as described in more detail with respect to FIG. 6) in order to minimize latency of the system in determining a potentially anomalous ATM customer session in substantially real time. Substantially real time may be on the order of several hundred milliseconds to several seconds. In some embodiments, the system may also be used to identify an anomaly associated with a subgroup of ATM customers. In the case of determining an anomaly for a subgroup of customers, the system may employ a similar process as described below with respect to a single customer, except the system may group certain subgroup of customers together based on metadata. For example, the system may group subgroups based on geographic area of customer interactions, based on certain time periods for customer interactions, by customer income level, or the like.

After the model has been trained, the system may encrypt every customer session activity encoded sequence 108 into a vector (e.g., a global latent vector 114) that may include 256 or more components. The global latent vector 114 for a particular customer session may represent the same of all activity during the customer session. The principle of operation of the machine learning model means that a customer session that is similar to a previous customer session will result in generated global latent vector which may be very similar to previous latent vectors generated based on the previous customer sessions. After the initial training process the distributed memory grid may be populated by a global latent vector for every customer interaction. The total number of records/latent vectors may be calculated as shown in Eq (2):

$$K = {\sum }_{i = 1}^{n} {S}^{i} \qquad ( 2 )$$

K may be understood as the total number of global latent vectors (e.g. global latent vectors 114) stored in the distributed memory grid. N may be the number of customers for which a global latent vector has been calculated during the training phase (e.g. based on customer session activity 108), and S is the number of sessions for a respective customer.

When a returning customer (e.g., Customer A) starts a new ATM customer session, the system may be configured to determine whether the new customer session for Customer A includes potentially anomalous activity by computing a Euclidean distance between an average of the previous embedding vectors (e.g., global latent vectors 114) for Customer A stored on the distributed memory grid and a global latent vector based on the new customer session. In some embodiments, the Euclidean distance function may be expressed as Eq (3):

$$L ( S , E ) = max {}_{j = 1}^{m} ( d ( S - {E}^{j} ) ) \qquad ( 3 )$$

S may be understood as the global latent vector corresponding to the new customer session, E^{j} are the previous embedding vectors for the respective customer (e.g., Customer A), and d is a Euclidean distance function. In some embodiments, instead of a max argument, the system may calculate the Euclidean distance between the new customer embedding vector and a mean square of the previous customer embedding vectors.

As described with respect to FIG. 1B, the ATM encoded sequence 108 (e.g., the plurality of tensors for a particular customer or group of customers) may be received by the system from a distributed memory grid (as described in more detail with respect to FIG. 6) and encrypted by the encoding layer of the RNN 112 into a global latent vector 114. To determine an anomalous activity, the system may receive a new ATM session activity 108 for a first customer and encrypt a global latent vector for the new ATM session activity 108. During the prediction process, the ATM session activities 108 may be received from a data lake (e.g., S3 storage) or from the ATM devices directly. ATM session activities 108 may be received by the system as an aggregated window operation. For example, the ATM session activities may be continuously uploaded to a framework for distributed processing over an unbounded data stream (e.g., using a framework such as Apache Flink™ and/or Kafka™. The system may monitor the ATM session activities 108 as they are included in the data stream. In some embodiments, in order to perform the steps of an exemplary method, the system may create finite sets of events from the unbounded data stream comprising ATM session activities 108. For example, the data may undergo window operations to create finite sets of events (e.g., data buckets) from the unbounded data stream. The ATM session activities 108 may be separated into discrete data buckets based on an internal customer identifier. Accordingly, the system is provided with a data stream including identifiable ATM customer session activities 108 for every discrete customer session. The discretization of the continuous data stream may be enabled by a session window, and more particularly a window operation that assigns events belonging to the same session into the same bucket (e.g., according to the customer identifier). In some embodiments, the window containing a respective ATM session activity 108 may be determined by a global progress metric that indicates the point in time when all events associated with a respective ATM session activity 108 have been received.

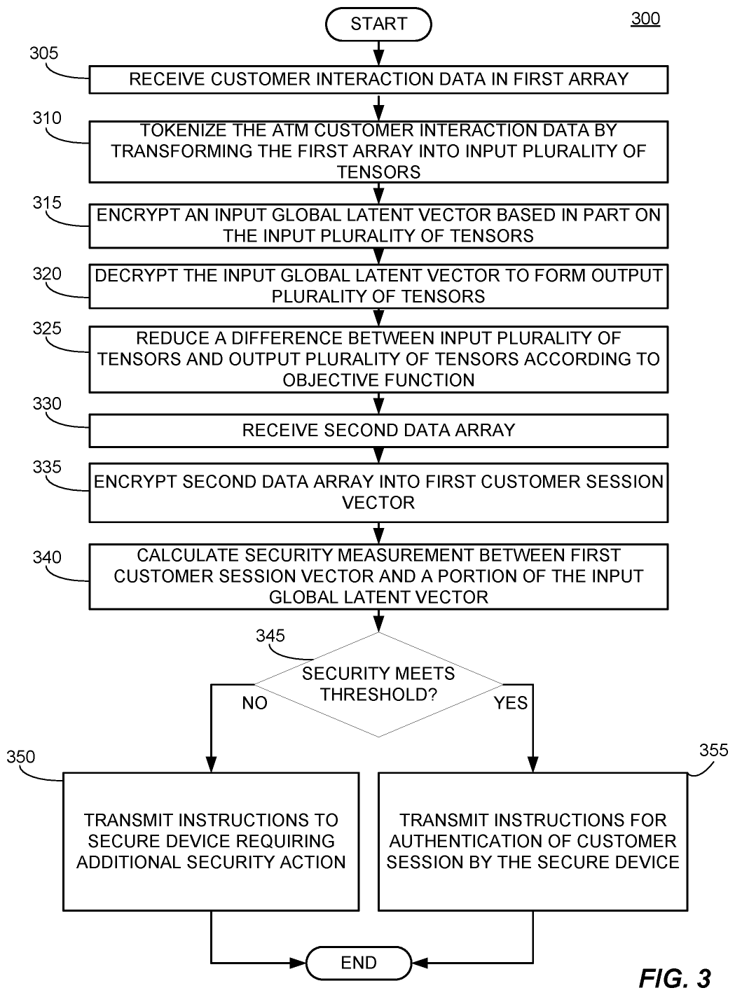

The system may further determine a security measurement between the global latent vector 114 and a previously generated global latent vector 114 that is based on previous ATM customer activity for the first customer. Accordingly, the system may use previous customer ATM behavior to determine whether current customer behavior is anomalous. As described in more detail with respect to FIGS. 3-5, when the security measurement does not exceed a predetermined threshold, the anomaly detection system may transmit instructions to the ATM (e.g., a secure device) indicative of an anomalous session and requiring additional security actions from the first customer before the authentication of the respective customer ATM session may be completed. When the system is employed to determine a temporal or geographical anomaly, the system may enable powerful insights of potentially fraudulent activity related to a particular geographical area and/or time period for a respective subgroup of customers. In some embodiments, the system may be configured to segment subgroups of customers based on behavioral anomalies to predict anomalous activity. For example, the system may identify subgroups based on potentially anomalous behaviors such as a customer making multiple small withdrawals to avoid a transaction being flagged for review, timing of actions (e.g., button inputs to the ATM not corresponding to human control), etc.

FIG. 3 is a flowchart of an exemplary method of unsupervised detection of anomalous ATM customer interactions during a customer session, in accordance with some embodiments. As shown in step 305 of method 300, the system (e.g. anomaly detection system 600) may receive customer interaction data (e.g., ATM logs 102) in a first data array. The customer interaction data may be received from a financial service provider system (e.g., financial service provider system 620, as described in more detail with respect to FIG. 6). The financial service provider system may include a plurality of secure devices (e.g. ATMs) with which a plurality of customers interact. ATM logs may be generated by respective ATMs and stored in a data lake or other storage mechanism associated with the respective financial institution, although in some embodiments, the ATM logs may be received in a continuous stream from the respective ATM directly (e.g., as described with respect to FIG. 1B). In some embodiments, after receiving the customer interaction data (e.g., ATM logs 102) in the first data array, the anomaly detection system may anonymize the customer interaction data by removing all personally identifiable information from the dataset. For example, the ATM customer interaction data may remove information such as a name of a respective customer, a date of birth, a social security number and/or PIN associated with the customer's account with the financial service provider, etc.

In step 310, the system may tokenize the customer interaction data by transforming the received data array into a first plurality of tensors, as described in more detail with respect to FIG. 1A-1B.

In step 315, the anomaly detection system 600 may encrypt a first global latent vector based in part on the first plurality of tensors resulting from tokenization of the ATM customer interaction data in step 310. As described in more detail with respect to FIG. 1B and FIG. 2, the first global latent vector may be a compressed data structure in comparison to the full text corpus included in the plurality of tensors. In some embodiments, the system may concatenate to the plurality of tensors of step 310 a mechanism, such as an attention mechanism, LSTM, or GRU, in order to rebalance weights of the hidden states of the bidirectional RNN to be less biased towards the final hidden layers proximal to the output layer of the RNN. Accordingly, an input paragraph vector (e.g. paragraph vector 110A, as described in more detail with respect to FIGS. 1A-1B and FIG. 2) may be provided as the input to the bidirectional RNN in step 315 in some embodiments.

In step 320, the anomaly detection system may decrypt the first global latent vector to form a second plurality of tensors. In embodiments, when a paragraph vector is the input to the bidirectional RNN, the first global latent vector may be decrypted to form an output paragraph vector (e.g. paragraph vector 110B, as described in more detail with respect to FIGS. 1A-1B and FIG. 2). The anomaly detection system may undergo self-supervised learning (e.g., identifying appropriate weights for each input layer of the bidirectional RNN) in order to reduce a difference between the input (e.g., the first plurality of tensors or the input paragraph vector) and the output (e.g., the second plurality of tensors or the output paragraph vector) (e.g., by reducing an error associated with the encoder and decoder layers of the model). Accordingly, in step 325, the system may reduce a difference between the input of the bidirectional RNN and the output of the bidirectional RNN according to an objective function (e.g., Eq (1)). In step 325, the anomaly detection system 600 may iteratively re-encrypt the first global latent vector while autonomously adjusting the weights of each input layer of the RNN, and iteratively recalculate the value of the loss function according to Equation (1), and as described in more detail with respect to FIG. 1B. After the system has optimized according to the objective of Equation (1), the bidirectional RNN may be deployed to determine anomalous activity across a population (e.g., anomalous activity for a particular subgroup of the population across a respective geographical area or a respective time period) or for a particular customer (e.g., by comparing previously generated embedding vectors corresponding to previous customer interaction data for a respective customer to a new embedding vector corresponding to a new ATM customer interaction for the respective customer).

In step 330, the anomaly detection system may receive a second data array. The second data array may include ATM logs for a first customer ATM interaction. Using the second data array, the system may transform the second data array using the trained bidirectional RNN into a first customer session vector in step 335. The customer session vector may be analogous to the global latent vector in that it comprises a compressed data structure containing entries correlated to the entries of the second data array. By employing the decoder of the bidirectional RNN, the second data array may be recovered as an output if the first customer session vector is decrypted by the decoder of the bidirectional RNN. However, in the present embodiment, the bidirectional RNN of the anomaly detection system 600 may already be trained according to steps 305-335, therefore it is not necessary to decrypt the first customer session vector to recover the full corpus of the second data array. Rather, in step 340, the system may calculate a security measurement between the first customer session vector and a portion of the first global latent vector. For example, the system may identify a portion of the first global latent vector corresponding to previous customer interaction data for the first customer based on the first customer identifier and determine the security measurement between the first portion of the global latent vector and the first customer session vector (e.g., by calculating the Euclidean distance according to Eq (3)).

In decision block 345, when the security measurement exceeds a predetermined threshold (e.g., when the Euclidean distance is less than a predetermined threshold), the system may determine that the first customer session vector does not indicate anomalous activity, and the method may move to step 355. When the security measurement does not exceed the predetermined threshold (e.g., when the Euclidean distance is more than the predetermined threshold), the system may determine that the first customer session vector indicates anomalous activity in step 350.

The security measurement may indicate how closely a customer session represented by the first customer session vector parallels previous customer interactions based on the aggregated session activity for the respective customer. Accordingly, in step 350, the system may transmit instructions to the respective ATM (e.g. secure device) instructing the ATM to require an additional security action from the first customer before the first customer session is completed. For example, the ATM system may require a secondary method of authenticating the customer. In some embodiments, the ATM system may require the multifactor authentication from the first customer, for example by sending a secure code to a computing device associated with the first customer and requiring the secure code to be entered into the ATM system to further authenticate the customer. In some embodiments, the ATM system may deny the transaction when the customer does not provide the additional security action within a predetermined timeframe to prevent fraudulent transactions.

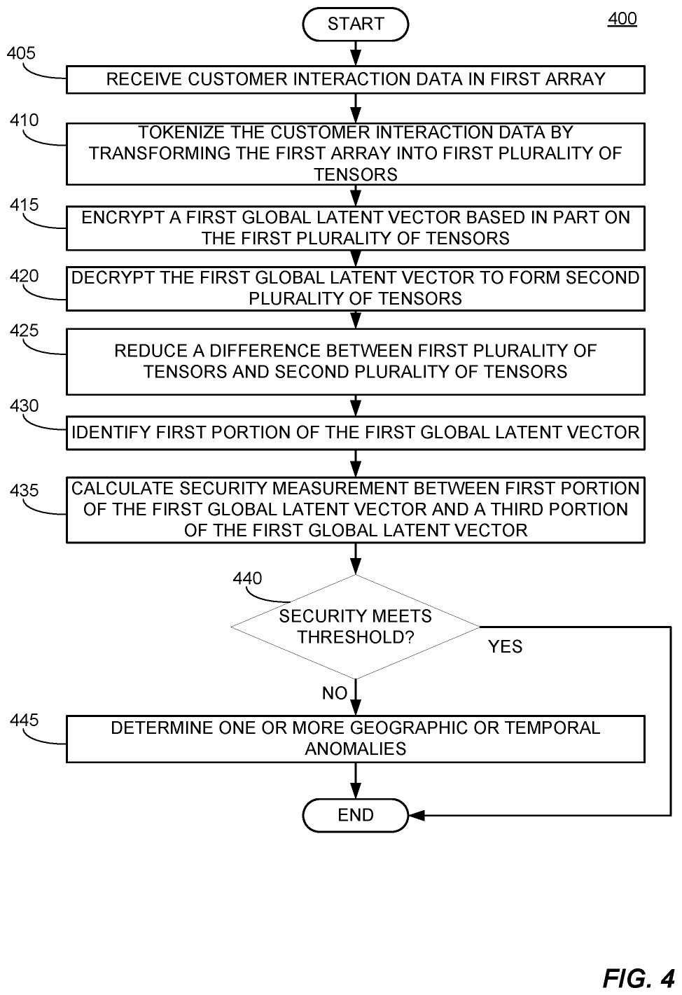

FIG. 4 is a flowchart of an exemplary method of identifying one or more geographic or temporal anomalies associated with a first subgroup of ATM customers, in accordance with some embodiments. Steps 405, 410, and 415, 420, and 425, associated with the autonomous training of bidirectional RNN, are substantially similar to that of steps 305, 310, 315, 320, and 325, respectively, and will be omitted here for brevity. In step 430, the anomaly detection system may identify a first portion of the first global latent vector. The first global latent vector may be a compressed data structure autonomously created by the bidirectional neural network including data entries indicative of aggregate customer activity. The autonomous training activity of the bidirectional RNN ensures that the first global latent vector may be decrypted (e.g., by a decoder of the RNN model) to recover the full corpus of information included in the first data array. However, when the bidirectional RNN model has already undergone self-supervised learning and minimize the error between the input and output of the model as described in more detail with respect to FIG. 3, and therefore it is unnecessary to decrypt the latent vector to recover the full corpus of information. Rather, the first portion of first global latent vector may be indicative of a first subgroup of customers of the aggregate customer ATM activity data (e.g., ATM data logs 102) for a specific geographical area or a specific time period. The system may additionally identify a third portion of the global latent vector, where the third portion is indicative of activity of the first subgroup of customers excluding the specific geographic area and/or specific time period. Accordingly, in step 435, the system may calculate the security measurement between the first portion of the first global latent vector and the third portion of the first global latent vector. Step 435 may be substantially similar to step 340 as described with respect to FIG. 3. In step 440, the system may determine whether the security measurement exceeds a predetermined threshold (e.g., by calculating the Euclidean distance according to Eq (3)). When the security measurement exceeds the predetermined threshold, the method may end. However, when the system determines that the similarity does not exceed the predetermined threshold, the method may move to step 445. In step 445, based on the security measurement not exceeding the predetermined threshold, the system may identify one or more geographic or temporal anomalies associated with the first subgroup of customers.

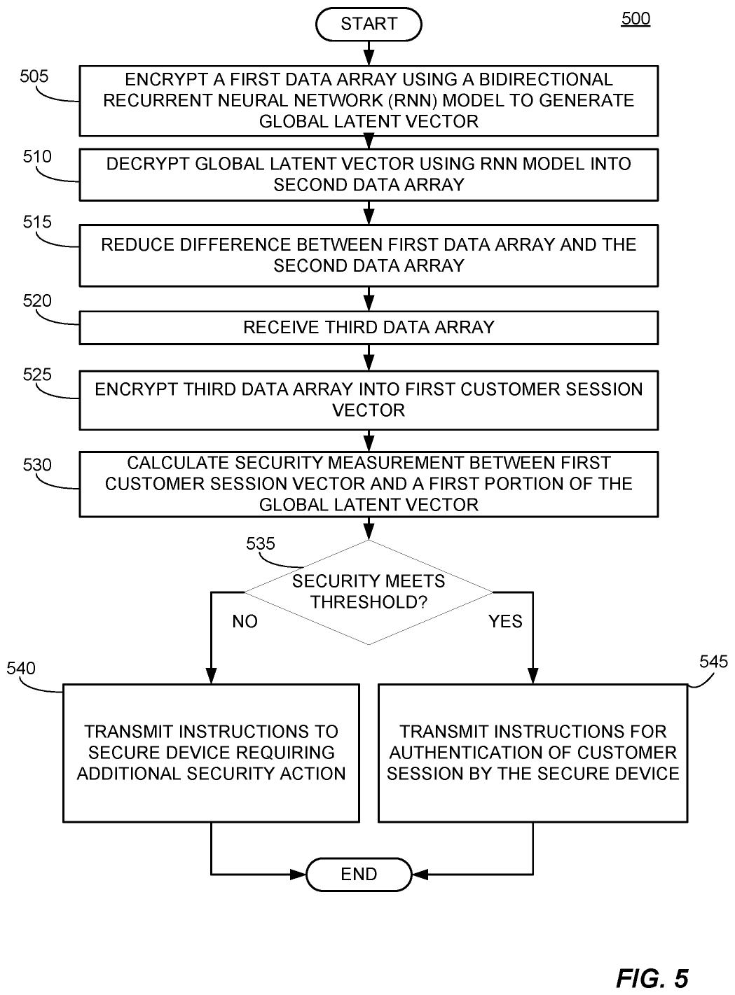

FIG. 5 is a flowchart of another exemplary method of unsupervised detection of anomalous customer interactions during a customer session, in accordance with some embodiments. In step 505 of method 500, the system may automatically process a first data array using a bidirectional RNN to generate a global latent vector. The global latent vector may be a compressed data structure that has been encrypted by being passed through a plurality of input layers of the bidirectional RNN encoder (e.g., encoding layer 112 as described with respect to FIGS. 1A-1B and FIG. 2).

In step 510 of method 500, the system may generate a second data array based on the global latent vector. For example, the system may utilize a decrypting layer of the bidirectional RNN (e.g., decoder layer 116, as described in FIG. 1B) to recover the full text corpus of the first data array. Accordingly, in step 515, the method may include reducing a difference between the first data array and the second data array according to an objective function (e.g., Eq(1)). In some embodiments, the method may include iteratively recoding the global latent vector to optimize the model according to the objective function of Equation (1). Once the bidirectional RNN has optimized the first global latent vector according to the objective function such that the input first data array and the output second data array are identical or substantially similar, the model may complete the self-supervised training process. In step 520, the method may include receiving a third data array. For example, the third data array may include information representative of a first customer session with a secure device (e.g., an ATM). Accordingly, in step 525, the method may include encrypting the third data array into a first customer session vector using the trained bidirectional RNN. In step 530, the method may include calculating the security measurement between the first customer session vector and a first portion of the global latent vector. The anomaly detection system 600 may identify the first portion of the global latent vector that is representative of previous customer activity to compare to the first customer session vector (e.g., using the customer session identifier). In step 535, the method may include determining whether the first customer session vector exceeds a predetermined threshold (e.g., by calculating a Euclidean distance according to Equation (3)) to the first portion of the global latent vector. When the security measurement exceeds the predetermined threshold, the method may move to step 545. When the security measurement does not exceed the predetermined threshold, the method may include transmitting instructions to the secure device (e.g., ATM) requiring additional security actions from the first customer before authentication of the first customer session in step 540. For example, the ATM may require a form of multi factor authentication from the first customer as an additional layer of security. In some embodiments, if the first customer fails to respond to the additional security action request from the ATM, the customer ATM session may be canceled for security purposes. Accordingly, an anomaly detection system 600 may enable unsupervised training using full text corpus of ATM session log data (e.g. ATM logs 102) and unsupervised detection of anomalous activity using the trained model. In step 545, when the security measurement exceeds the predetermined threshold (e.g., when the Euclidean distance as calculated according to Eq(3) is below a predetermined threshold), the method may include transmitting instructions to the secure device (e.g., ATM) for authentication of the first customer session by the secure device.

FIG. 6 shows a diagram of an exemplary system that may be configured to perform one or more software processes that, when executed, provide a silent transaction terminal alert. The components and arrangements shown in FIG. 6 are not intended to limit the disclosed embodiments as the components used to implement the disclosed processes and features may vary.

In accordance with disclosed embodiments an anomaly detection system 600 may include an anomaly detection device 610 and a financial service provider system 620 each communicating over a network 630. According to some embodiments, the financial service provider system 620 may include a plurality of ATMs 622 (e.g., ATM 622A, ATM 622B, ATM 622C, etc.) and a distributed memory grid 624. In some embodiments, customers of the financial service provider system 620 may wish to interact with the plurality of ATMs associated with the financial service provider system 620. ATM log data may be created and stored in a distributed memory grid 624 associated with the financial service provider. The financial service provider system 620 may be connected to the anomaly detection device 610 either directly or via the network 530. Other components known to one of ordinary skill in the art may be included in the silent transaction terminal alert system 100 to process, transmit, provide, and receive information consistent with the disclosed embodiments.

The anomaly detection device 610 may be a computer-based system. For example, the anomaly detection device 610 may include a general purpose or notebook computer, a mobile device with computing ability, a server, a desktop computer, tablet, or any combination of these computers and/or affiliated components. The anomaly detection device 610 may include one or more sensors such as a camera and microphone (i.e., audiovisual monitoring systems), gyroscope and/or a GPS receiver. The anomaly detection device 610 may be configured with storage that stores one or more operating systems that perform known operating system functions when executing by one or more processors. For example, the operating systems may include Microsoft Windows™, Unix™, Linux™, Apple™ operating systems, Personal Digital Assistant (PDA) type operating systems (e.g. Mircosoft CE™), or other types of operating systems, nonexclusively. Further, the anomaly detection device 610 may include communication software that, when executed by a processor, provides communications with the network 630, such as web browser software, tablet, or smart handheld device networking software, etc. The anomaly detection device 610 may be a device that executes mobile applications, such as a tablet or a mobile device. Although reference is made specifically to the anomaly detection device 610, a person of ordinary skill in the art would understand that the financial service provider system 620, may have some or all of the components and capabilities of the anomaly detection device 610.

The financial service provider system 620 may allow a financial service provider, such as a bank, a credit card company, a merchant, a lender, etc., to offer and provide a secure transaction terminal authentication system in order to more effectively secure a user's financial transactions by working in tandem with anomaly detection device 610. The financial service provider system 120 may be a computer-based system including computer system components, such as one or more servers, desktop computers, workstations, tablets, handheld computing devices, memory devices, and/or internal network(s) connecting the components. As shown in FIG. 6, the financial service provider system 120 may include a plurality of ATMs 622. Customers of the financial service provider system 620 may interact with ATMs 622, and the ATM log data (e.g. ATM logs 102) may be generated based on the customer interactions and stored in the distributed memory grid 624. The distributed memory grid 624 may be configured to store the ATM log data in a way that minimizes latency between components of the anomaly detection device 610 and the financial service provider system 620.

Network 630 may comprise any type of computer networking arrangement used to exchange data. For example, network 630 may be the Internet, a private data network, or a virtual private network using a public network such as the Internet. Network 630 may also include a public switched telephone network (“PSTN”) and/or a wireless network.

The anomaly detection device 610 is shown in more detail in FIG. 7. The financial service provider system 620 may have a similar structure and components that are similar to those described with respect to anomaly detection device 610. As shown, anomaly detection device 610 may include a processor 710, an input/output (“I/O”) device 720, a memory 730 containing an operating system (“OS”) 740 and a program 750. For example, anomaly detection device 610 may be a single server or may be configured as a distributed computer system including multiple servers or computers that interoperate to perform one or more of the processes and functionalities associated with the disclosed embodiments. In some embodiments, the anomaly detection device 610 may further include a display (or a display interface), a peripheral interface, a transceiver, a mobile network interface in communication with the processor 710, a bus configured to facilitate communication between the various components of the anomaly detection device 610, and a power source configured to power one or more components of the anomaly detection device 610. A display may include any conventional display mechanism such as a flat panel display, projector, or any other display mechanism known to those having ordinary skill in the art. In some embodiments, a display, in conjunction with suitable stored instructions, may be used to implement a graphical user interface. In other embodiments, a display may include a display interface configured to receive or communicate with one or more external displays. The anomaly detection device may further include a sound interface, a camera interface, a telephony subsystem, an antenna interface, and a GPS receiver.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

In some embodiments, a transceiver may be configured to communicate with compatible devices and ID tags when they are within a predetermined range. A transceiver may be, for example, compatible with one or more of: radio-frequency identification (RFID), near-field communication (NFC), Bluetooth®, low-energy Bluetooth® (BLE), WiFi™, ZigBee®, ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor(s) 710 to communicate with other devices via wired or wireless networks, whether local or wide area, private or public, as known in the art. A power source may be configured to provide an appropriate alternating current (AC) or direct current (DC) to power components.

Processor 710 may include one or more of a microprocessor, microcontroller, digital signal processor, co-processor or the like or combinations thereof capable of executing stored instructions and operating upon stored data. Memory 730 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 710 may be one or more known processing devices, such as a microprocessor from the Pentium™ family manufactured by Intel™ or the Ryzen™ family manufactured by AMD™ Processor 710 may constitute a single core or multiple core processor that executes parallel processes simultaneously. For example, processor 710 may be a single core processor that is configured with virtual processing technologies. In certain embodiments, processor 710 may use logical processors to simultaneously execute and control multiple processes. Processor 710 may implement virtual machine technologies, or other similar known technologies to provide the ability to execute, control, run, manipulate, store, etc. multiple software processes, applications, programs, etc. In another embodiment, processor 710 may include a multiple-core processor arrangement (e.g., dual or quad core) that is configured to provide parallel processing functionalities to allow anomaly detection device 610 to execute multiple processes simultaneously. One of ordinary skill in the art would understand that other types of processor arrangements could be implemented that provide for the capabilities disclosed herein.

Anomaly detection device 610 may include one or more storage devices configured to store information used by processor 710 (or other components) to perform certain functions related to the disclosed embodiments. In one example, anomaly detection device 610 may include memory 730 that includes instructions to enable processor 710 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, anomaly detection device 610 includes memory 730 that includes instructions that, when executed by processor 710, perform one or more processes consistent with the functionalities disclosed herein. Methods, systems, and articles of manufacture consistent with disclosed embodiments are not limited to separate programs or computers configured to perform dedicated tasks. For example, anomaly detection device 610 may include memory 730 that may include one or more programs 750 to perform one or more functions of the disclosed embodiments. Moreover, processor 710 may execute one or more programs 750 located remotely from the anomaly detection device 610. For example, the anomaly detection device 610 may transmit instructions to one or more components of the financial service provider system 620 (e.g., to one of the plurality of ATMs 622 to require an additional security action from a customer).

Memory 730 may include one or more memory devices that store data and instructions used to perform one or more features of the disclosed embodiments. Memory 730 may also include any combination of one or more databases controlled by memory controller devices (e.g., server(s), etc.) or software, such as document management systems, Microsoft SQL databases, SharePoint databases, Oracle™ databases, Sybase™ databases, or other relational databases. Memory 230 may include software components that, when executed by processor 210, perform one or more processes consistent with the disclosed embodiments.

Anomaly detection device 610 may also be communicatively connected to one or more distributed memory grids (e.g., distributed memory grid 624) locally or through a network (e.g., network 630). The distributed memory grid may be configured to aggregate and store customer ATM logs and may be accessed and/or managed by financial service provider system 620 and/or anomaly detection device 610. By way of example, the remote memory devices may be document management systems, Microsoft SQL database, SharePoint databases, Oracle™ databases, Sybase™ databases, or other relational databases. Systems and methods consistent with disclosed embodiments, however, are not limited to separate databases or even to the use of a database.

Anomaly detection device 610 may also include one or more I/O devices 720 that may comprise one or more interfaces for receiving signals or input from devices and providing signals or output to one or more devices that allow data to be received and/or transmitted by anomaly detection device 610. For example, anomaly detection device 610 may include interface components, which may provide interfaces to one or more input devices, such as one or more keyboards, mouse devices, touch screens, track pads, trackballs, scroll wheels, digital cameras, microphones, sensors, and the like, that anomaly detection device 610 to receive data from one or more users. In other exemplary embodiments, the I/O devices 720 may serve as the sound interface and/or the camera interface to present information to a user and capture information from a device's environment including instructions from the device's user. As additional examples, input components may include an accelerometer (e.g., for movement detection), a magnetometer, a digital camera, a microphone (e.g., for sound detection), an infrared sensor, an optical sensor, and a GPS receiver.

In exemplary embodiments of the disclosed technology, the anomaly detection device 610 may include any number of hardware and/or software applications that are executed to facilitate any of the operations. In example implementations, one or more I/O interfaces facilitate communication between the anomaly detection device 610 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the anomaly detection device 610 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of anomaly detection device 610 may include a greater or lesser number of components than those illustrated.

In example embodiments of the disclosed technology, anomaly detection system 600 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

### Exemplary Use Cases

The following exemplary use cases describe examples of a typical system flow pattern. They are intended solely for explanatory purposes and not in limitation. The system may undergo unsupervised learning of ATM customer activity based on ATM logs received from the financial service provider system and determine an anomaly for a particular customer or for a subgroup of the population associated with a respective geographic location or time period, without requiring traditional retraining of the model.

The system (e.g., system 600) can receive a customer interaction data (e.g. ATM log data 102). For example, the system may communicate with a data lake (e.g., S3 storage) which aggregates and stores ATM customer session data for a plurality of customers associated with a respective financial service provider (e.g., financial service provider system 620). However, in some embodiments, the customer log data may be sent to the system in substantially real time utilizing a window operation that may create finite sets of customer session activities (e.g., segregated by respective customer according to a customer identifier) from a continuous stream of ATM customer session activity from a plurality of ATM devices. The goal of the system may be to utilize a bidirectional recurrent neural network (RNN) to undergo unsupervised training based on aggregate customer activity. The bidirectional RNN may receive ATM log data and initially undergo a self-tokenization process, where the customer data may be translated into a plurality of tensors representative of the cumulative data. In some embodiments, the plurality of tensors may be concatenated to form a paragraph input vector. The system may provide the plurality of tensors, a first data array including the ATM log data, or the paragraph vector as an input to the bidirectional RNN. The bidirectional RNN may encrypt the input into a global latent vector, which may represent a probabilistic distribution representative of the input vector. To complete the unsupervised training process, the system may decrypt the global latent vector to determine an output vector. By optimizing according to an objective function and automatically readjusting weights of the plurality of hidden states of the bidirectional RNN, the system may maximize a security measurement between they input vector and the output vector according to Equation (1). Accordingly, the system may undergo self-supervised learning of how to autonomously encrypt ATM customer data into a probabilistic distribution represented by the global latent vector. Once the model is trained, the global latent vector may be utilized to determine whether future customer activity for a respective customer or across a respective subgroup of customers may be associated with anomalous activity. For example, the system may receive a new customer session activity associated with Customer A initiating a transaction at ATM 622A. The system may transform the ATM customer session data for the respective session activity into a plurality of tensors according to a self-tokenization process, and apply the plurality of tensors as the input to the trained bidirectional RNN. Accordingly, the system may produce a customer session vector for Customer A's new customer session activity with ATM 622A. The system may then calculate a security measurement between the customer session vector and a portion of the global latent vector associated with Customer A's previous ATM activities. When the security measurement between the customer session vector and the portion of the global latent vector does not exceed a predetermined threshold, the system may determine that Customer A's current activity with ATM 622A is potentially fraudulent, and transmit instructions to ATM 622A to require additional security measures from Customer A (e.g., by calculating a Euclidean distance according to Equation (3)). For example, ATM 622A may transmit a secure code to a mobile device associated with Customer A and require the secure code to be entered into ATM 622A as a second factor authentication. If Customer A fails to respond to the additional security action, financial service provider system 620 may deny the ATM transaction for Customer A. When the security measurement between the customer session vector and the portion of the global latent vector exceeds the predetermined threshold, the system may transmit instructions to ATM 622A for authentication of the customer session by ATM 622A. In some embodiments, the system may determine a geographic or temporal anomaly for a particular subgroup of Customers. For example, the system may isolate a first portion of the global latent vector indicative of a Customer Subgroup B ATM interactions associated with a particular geographic area or time period. The system may compare the first portion of the global latent vector to a second portion of the global latent vector associated with Customer Subgroup B ATM interactions excluding the interactions of the first portion. When the similarity measurement between the two respective portions of the global latent vector do not exceed a predetermined threshold, the system may determine that the first portion of the global latent vector indicates anomalous and/or potentially fraudulent activity across Customer Subgroup B for the respective geographic area or time period associated with the first portion of the global latent vector.

Examples of the present disclosure relate to systems and methods for unsupervised detection of anomalous customer interactions during a customer session. In one aspect, a system for unsupervised detection of anomalous customer interactions to secure and authenticate a customer session is disclosed. The system may implement a method according to the disclosed embodiments. The system may receive, from a distributed memory grid, customer interaction data including a first data array indicative of a plurality of ATM customer interactions. In some embodiments, the system may optionally anonymize the customer interaction data by removing personally identifiable customer information from the first data array. The system may tokenize the ATM customer interaction data. The tokenization may include transforming the first data array into a first plurality of tensors. Each of the first plurality of tensors may include data indicative of the plurality of ATM customer interactions. The system may encrypt a first global latent vector based in part on the first plurality of tensors using an encoder of a bidirectional recurrent neural network (RNN). The system may decrypt, using a decoder of the bidirectional RNN, the first global latent vector to form a second plurality of tensors. The system may then optimize against an objective function that is associated with minimizing the reconstruction error between the input plurality of tensors and the output plurality of tensors according to the objective function. The optimization of the objective function may involve iteratively re-encrypting the first global latent vector. The system may receive a second data array including a first customer session with a first secure device (e.g., an ATM). The system may transform the second data array into a first customer session vector. The system may calculate a security measurement between a first portion of the first global latent vector indicative of one or more previous first customer sessions and the first customer session vector. When the security measurement does not exceed a predetermined threshold, the system may transmit instructions to the secure device (e.g., ATM) indicative of an anomalous session and requiring an additional security action before authentication of the first customer session.

In some embodiments, a document vector is concatenated to the first global latent vector before being decrypted by the decoder. The document vector may include weights of hidden states of the bidirectional RNN and the first global latent vector based on a final hidden state of the bidirectional RNN. In some embodiments, the security measurement further includes calculating a Euclidean distance.

In some embodiments, the system may further iteratively update a stored value of the first global latent vector in the distributed memory grid based on the objective function. In some embodiments, minimizing the loss function may further include minimizing a Kullback-Leibler divergence (KLD) between a prior distribution of the first plurality of tensors and the first global latent vector while maximizing a conditional probability associated with decrypting the second plurality of tensors to match the first plurality of tensors. In some embodiments, the security measurement is performed in substantially real-time.

In some embodiments, the additional security action may include requiring the first customer to provide multi-factor authentication before authentication of the first customer session.

In some embodiments, the system may further identify at least a second portion of the first global latent vector, the second portion indicative of a first subgroup of the plurality of ATM customer interactions. The first subgroup of ATM customer interactions may include interactions of a first subgroup of customers that are associated with at time period or geographic location. The system may calculate the security measurement between the second portion of the first global latent vector and a third portion of the first global latent vector, where the third portion is indicative of customer interactions of the first subgroup of customers that are not associated with the time period or the geographic location. The system may determine one or more geographic or temporal anomalies associated with the first subgroup of customers based on the security measurement not exceeding the predetermined threshold.

In another aspect a system for unsupervised detection of anomalous to secure and authenticate a customer session are disclosed. The system may receive customer interaction data including a first data array indicative of a plurality of ATM customer interactions. Optionally, the system may anonymize the customer interaction data by removing personally identifiable customer information from the first data array. The system may tokenize the customer interaction data. The tokenizing may include transforming the first data array into a first plurality of tensors, where each of the first plurality of tensors may include data indicative of the plurality of customer interactions. The system may encrypt a first global latent vector based in part on the first plurality of tensors. The system may encrypt the first global latent vector using an encoder of a bidirectional recurrent neural network (RNN). The system may decrypt, using a decoder of the bidirectional RNN, the first global latent vector to form a second plurality of tensors. The system may reduce a difference between the first plurality of tensors and the second plurality of tensors according to an objective function. The optimization may include iteratively re-encrypting the first global latent vector. The system may identify a first portion of the first global latent vector that is indicative of a first subgroup of the plurality of customer interactions. The first subgroup of the plurality of customer interactions may include interactions of a first subgroup of customers that are associated with a time period or geographic location. The system may calculate the security measurement between the first portion of the first global latent vector and a third portion of the first global latent vector. The third portion may indicate customer interactions of the first subgroup of customers that are not associated with the time period or the geographic location. The system may determine one or more geographic or temporal anomalies associated with the first subgroup of customers based on the security measurement not exceeding a predetermined threshold.

In some embodiments, a document vector may be concatenated to the first global latent vector before being decrypted by the decoder. The document vector may include weights of hidden states of the bidirectional RNN and the first global latent vector based on a final hidden state of the bidirectional RNN. In some embodiments, the similarity measurement further includes calculating a Euclidean distance. In some embodiments, the system may iteratively update a stored value of the first global latent vector in the distributed memory grid based on optimizing the model based on the objective function. In some embodiments, optimizing the objective function may include minimizing a Kullback-Leibler divergence (KLD) between a prior distribution of the first plurality of tensors and the first global latent vector while maximizing a conditional probability associated with decrypting the second plurality of tensors to match the first plurality of tensors. In some embodiments, the security measurement is performed in substantially real-time.

In some embodiments, the system may receive a second data array including a first customer session with a first secure device (e.g., an ATM). The system may encrypt the second data array into a first customer session vector. The system may calculate the security measurement between a second portion of the first global latent vector indicative of one or more previous first customer sessions and the first customer session vector. When the security measurement does not exceed the predetermined threshold, the system may transmit instructions to the secure device indicative of an anomalous session and requiring an additional security action from a first customer before authentication of the first customer session. When the security measurement exceeds the predetermined threshold, transmit instructions for authentication of the first customer session by the secure device. In some embodiments, the additional security action may include requiring the first customer to provide multi-factor authentication before authentication of the first customer session.

In another aspect, a computer implemented method for detecting anomalous customer interactions during a customer session is disclosed. The method may include encrypting a first data array that includes a plurality of customer interactions using a bidirectional recurrent neural network (RNN) model to generate a global latent vector. The method may include decrypting the global latent vector, using the bidirectional RNN model, into a second data array. The method may include reducing a difference between the first data array and the second data array according to an objective function. The method may include receiving a third data array including a first customer session with a first secure device. The method may include encrypting the third data array into a first customer session vector. The method may include calculating the security measurement between a first portion of the global latent vector and the first customer session before authentication of the first customer session. The method may include transmitting instructions to the secure device indicative of an anomalous session and requiring an additional security action from the first customer before authentication of the first customer session when the security measurement does not exceed a predetermined threshold. The method may include transmitting instructions for authentication of the first customer session by the secure device when the security measurement exceeds the predetermined threshold.

In some embodiments, a document vector may be concatenated to the global latent vector before being decrypted by a decoder associated with the bidirectional RNN model. The document vector may include weights of hidden states of the bidirectional RNN model and the global latent vector based on a final hidden state of the bidirectional RNN. In some embodiments, the security measurement may include calculating a Euclidean distance. In some embodiments, the security measurement is performed in substantially real-time.

In some embodiments, maximizing the similarity measurement may include minimizing a Kullback-Leibler divergence (KLD) between a prior distribution of the first data array and the global latent vector while maximizing a conditional probability associated with decrypting the second data array to match the first data array. In some embodiments, the weights of the hidden states of the bidirectional RNN may include one of an attention mechanism, a long short-term memory, a gated recurrent unit, or combinations thereof. In some embodiments, the first data array, the second data array, the third data array, the first customer session vector, and the global latent vector are stored on a distributed memory grid. In some embodiments, the additional security action may further include requiring the first customer to provide multi-factor authentication before authentication of the first customer session.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described herein with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described herein with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

We claim:

1. A system for unsupervised detection of anomalous customer interactions to secure and authenticate a customer session, the system comprising:
one or more processors;
a memory in communication with the one or more processors and storing instructions that, when executed by the one or more processors, are configured to cause the system to:
receive customer interaction data comprising a first data array indicative of a plurality of customer interactions;
tokenize the customer interaction data, the tokenizing comprising transforming the first data array into an input plurality of tensors, each of the input plurality of tensors comprising data indicative of the plurality of customer interactions;
encrypt, using an encoder of a bidirectional recurrent neural network (RNN), an input global latent vector based in part on the input plurality of tensors;
decrypt, using a decoder of the bidirectional RNN, the input global latent vector to form an output plurality of tensors;
reduce a difference between the input plurality of tensors and the output plurality of tensors according to an objective function;
receive a second data array comprising a first customer session with a first secure device;
encrypt the second data array into a first customer session vector;
calculate a security measurement between a first portion of the input global latent vector indicative of one or more previous first customer sessions and the first customer session vector;
when the security measurement does not exceed a predetermined threshold, transmit instructions to the first secure device indicative of an anomalous session and requiring an additional security action from a first customer before authentication of the first customer session; and
when the security measurement exceeds the predetermined threshold, transmit instructions for authentication of the first customer session by the first secure device.

2. The system of claim 1, wherein a document vector is concatenated to the input global latent vector before being decrypted by the decoder, the document vector comprising weights of hidden states of the bidirectional RNN and the input global latent vector based on a final hidden state of the bidirectional RNN.

3. The system of claim 1, wherein the security measurement further comprises calculating a Euclidean distance.

4. The system of claim 1, further comprising iteratively updating a stored value of the input global latent vector in a distributed memory grid based on the objective function.

5. The system of claim 1, wherein the security measurement is performed in substantially real-time.

6. The system of claim 1, wherein the additional security action further comprises requiring the first customer to provide multi-factor authentication before authentication of the first customer session.

7. The system of claim 1, wherein the instructions, when executed by the one or more processors, are further configured to cause the system to:
identify at least a second portion of the input global latent vector;
calculate the security measurement between the second portion of the input global latent vector and a third portion of the input global latent vector; and
determine one or more geographic or temporal anomalies based on the security measurement not exceeding the predetermined threshold.

8. A system for unsupervised detection of anomalous customer interactions to secure and authenticate a customer session, the system comprising:
one or more processors;
a memory in communication with the one or more processors and storing instructions that, when executed by the one or more processors, are configured to cause the system to:
receive customer interaction data comprising a first data array indicative of a plurality of customer interactions;
tokenize the customer interaction data, the tokenizing comprising transforming the first data array into a first plurality of tensors, each of the first plurality of tensors comprising data indicative of the plurality of customer interactions;
encrypt, using an encoder of a bidirectional recurrent neural network (RNN), a first global latent vector based in part on the first plurality of tensors;
decrypt, using a decoder of the bidirectional RNN, the first global latent vector to form a second plurality of tensors;
reduce a difference between the first plurality of tensors and the second plurality of tensors according to an objective function;
identify at least a first portion of the first global latent vector;
calculate a security measurement between the first portion of the first global latent vector and a third portion of the first global latent vector; and
determine one or more geographic or temporal anomalies based on the security measurement not exceeding a predetermined threshold.

9. The system of claim 8, wherein a document vector is concatenated to the first global latent vector before being decrypted by the decoder, the document vector comprising weights of hidden states of the bidirectional RNN and the first global latent vector based on a final hidden state of the bidirectional RNN.

10. The system of claim 8, wherein the security measurement further comprises calculating a Euclidean distance.

11. The system of claim 8, further comprising iteratively updating a stored value of the first global latent vector in a distributed memory grid based on the objective function.

12. The system of claim 8, wherein the security measurement is performed in substantially real-time.

13. The system of claim 8, wherein the instructions, when executed by the one or more processors, are further configured to cause the system to:
receive a second data array comprising a first customer session with a first secure device;
encrypt the second data array into a first customer session vector;
calculate the security measurement between a second portion of the first global latent vector indicative of one or more previous first customer sessions and the first customer session vector;
when the security measurement does not exceed the predetermined threshold, transmit instructions to the first secure device indicative of an anomalous session and requiring an additional security action from a first customer before authentication of the first customer session; and
when the security measurement exceeds the predetermined threshold, transmit instructions for authentication of the first customer session by the first secure device.

14. The system of claim 13, wherein the additional security action further comprises requiring the first customer to provide multi-factor authentication before authentication of the first customer session.

15. A computer-implemented method for detecting anomalous customer interactions during a customer session, the method comprising:
encrypting a first data array comprising a plurality of customer interactions using a bidirectional recurrent neural network (RNN) model to generate a global latent vector;
decrypting the global latent vector, using the bidirectional RNN model, into a second data array;
reducing a difference between the first data array and the second data array according to an objective function;
receiving a third data array comprising a first customer session with a first secure device;
encrypting the third data array into a first customer session vector;
calculating a security measurement between a first portion of the global latent vector and the first customer session vector;
when the security measurement does not exceed a predetermined threshold, transmitting instructions to the first secure device indicative of an anomalous session and requiring an additional security action from a first customer before authentication of the first customer session; and
when the security measurement exceeds the predetermined threshold, transmit instructions for authentication of the first customer session by the first secure device.

16. The method of claim 15, wherein a document vector is concatenated to the global latent vector before being decrypted by a decoder associated with the bidirectional RNN model, the document vector comprising weights of hidden states of the bidirectional RNN model and the global latent vector based on a final hidden state of the bidirectional RNN model.

17. The method of claim 15, wherein the security measurement further comprises calculating a Euclidean distance.

18. The method of claim 15, wherein the security measurement is performed in substantially real-time.

19. The method of claim 15, wherein the additional security action further comprises requiring the first customer to provide multi-factor authentication before authentication of the first customer session.

20. The method of claim 15, wherein the first customer session vector and the global latent vector are stored on a distributed memory grid.
